(19) United States
(12) Patent Application Publication
(10) Pub. No.: US 2025/0276270 A1
(43) Pub. Date: Sep. 4, 2025

(54) METHOD FOR GAS PURITY IMPROVEMENT USING VACUUM SWING ADSORPTION

(71) Applicant: KLA CORPORATION, Milpitas, CA (US)

(72) Inventors: William VAN HOOMISSEN, San Jose, CA (US); Bhupendra PATEL, San Jose, CA (US); Priyanka KARNATI, Fremont, CA (US)

(21) Appl. No.: 19/002,945

(22) Filed: Dec. 27, 2024

Related U.S. Application Data
(60) Provisional application No. 63/560,781, filed on Mar. 4, 2024.

(51) Int. Cl. B01D 53/047; B01D 53/053; B01D 53/30

(52) U.S. Cl. CPC B01D 53/0476; B01D 53/053; B01D 53/30; B01D 2256/18; B01D 2257/11; B01D 2259/40009; B01D 2259/45

(57) ABSTRACT

The method includes pressurizing a gas column by supplying an input gas from an input mass flow controller and exhausting an output gas from the gas column through an output mass flow controller. The input gas includes at least 99.9% Xe and 0.05% to 0.1% Ar. An input mass flow rate of the input mass flow controller is greater than an output mass flow rate mass flow rate of the output mass flow controller to adsorb Xe into an adsorbent in the gas column. In response to the gas column reaching a maximum pressure, the input gas supply is stopped, and the output gas is purged from the gas column. The output gas includes less than 99.9% Xe and greater than 0.1% Ar. The purified gas is extracted from the gas column to desorb the Xe from the adsorbent. The purified gas includes at least 99.99% Xe.

### CROSS-REFERENCE TO RELATED APPLICATIONS

This application claims priority to the provisional patent application filed Mar. 4, 2024, and assigned U.S. App. Ser. No. 63/560,781, the entire disclosure of which is hereby incorporated by reference.

### FIELD OF THE DISCLOSURE

This disclosure relates to gas purification processes for use in semiconductor manufacturing.

### BACKGROUND OF THE DISCLOSURE

Evolution of the semiconductor manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it determines the return-on-investment for a semiconductor manufacturer.

Fabricating semiconductor devices, such as logic and memory devices, typically includes processing a semiconductor wafer using a large number of fabrication processes to form various features and multiple levels of the semiconductor devices. For example, lithography is a semiconductor fabrication process that involves transferring a pattern from a reticle to a photoresist arranged on a semiconductor wafer. Additional examples of semiconductor fabrication processes include, but are not limited to, chemical-mechanical polishing (CMP), etch, deposition, and ion implantation. An arrangement of multiple semiconductor devices fabricated on a single semiconductor wafer may be separated into individual semiconductor devices.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Some inspection and fabrication processes rely on a supply of inert gas (e.g., Xenon), in which the accuracy and quality of these processes relies on the purity of the supplied gas. After use, the inert gas may be mixed with various contaminants. Thus, in order to reuse the inert gas in future processes, the gas may be purified to at least partially remove the contaminants from the gaseous mixture. However, existing pressure swing adsorption methods fail to purify the gas to high enough concentrations. This leads to accepting the level of reduced purity (and corresponding reduced accuracy and quality of the corresponding inspection or fabrication process) or introduction of new gas supply into the system, which increases costs. While other distillation technologies can be used to reach higher purity levels, these systems are complex and carry high implementation and operating costs, which may not be feasible for low volume applications.

Therefore, what is needed is an improved method for gas purification.

### BRIEF SUMMARY OF THE DISCLOSURE

An embodiment of the present disclosure provides a method. The method may comprise pressurizing a gas column by supplying an input gas from an input mass flow controller and exhausting an output gas from the gas column through an output mass flow controller. The input gas may comprise at least 99.9% Xe and 0.05% to 0.1% Ar. The gas column may contain an adsorbent. An input mass flow rate of the input mass flow controller may be greater than an output mass flow rate mass flow rate of the output mass flow controller to adsorb Xe into the adsorbent.

In response to the gas column reaching a maximum pressure, the method may further comprise stopping the input gas supplied to the gas column and purging the output gas from the gas column. The output gas may comprise less than 99.9% Xe and greater than 0.1% Ar.

The method may further comprise extracting purified gas from the gas column to desorb the Xe from the adsorbent. The purified gas may comprise at least 99.99% Xe.

In some embodiments, before extracting the purified gas from the gas column, the method may further comprise receiving, with a residual gas analyzer, a gas sample of the output gas purged from the gas column. The method may further comprise measuring, with the residual gas analyzer, an Ar concentration of the gas sample. In response to the Ar concentration of the gas sample being less than 0.01%, the method may further comprise re-routing the output gas from an exhaust port to an outlet port.

In some embodiments, the exhaust port may be connected to a gas recycling system configured to increase an Xe concentration of the output gas to up to 99.9% Xe.

In some embodiments, the outlet port may be connected to a storage tank configured to store the purified gas.

In some embodiments, the outlet port may be connected to a semiconductor inspection system configured to supply the purified gas.

In some embodiments, the input gas supplied to the gas column through the input mass flow controller may be connected to a gas recycling system configured reduce an Ar concentration of the input gas to 0.05% to 0.1% Ar.

In some embodiments, the output gas may be purged from the gas column by vacuum pressure from a vacuum pump.

In some embodiments, the purified gas may comprise at least 99.999% Xe.

In some embodiments, the adsorbent may be configured to preferentially adsorb Xe compared to Ar.

In some embodiments, the step of extracting the purified gas from the gas column may be performed after a preset duration of purging the output gas from the gas column.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram of a system according to an embodiment of the present disclosure;

FIG. 2 is a diagram of a system according to another embodiment of the present disclosure;

FIG. 3 is a flowchart of a method according to an embodiment of the present disclosure;

FIG. 4 is a graph of flow and pressure measurements of an example of the present disclosure; and

FIG. 5 is a graph of Ar concentration measurements of an example of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

An embodiment of the present disclosure provides a system 100. The system 100 may be configured to provide increased purification of a gas stream. For example, the system 100 may receive gas from a gas recycling system and improve the purity of the gas. In an instance, the system 100 may receive gas from a Xenon Recycling System (XRS). The XRS may use pressure swing adsorption (PSA) technology to separate an incoming gaseous mixture of Argon and Xenon (e.g., about 85% Ar and about 15% Xe) into purified Xe and waste Ar. However, the purified Xe produced by the XRS may be only about 99.5% to about 99.95% Xe. The system 100 may therefore be used as a post-process of the XRS to increase the Xe purity to 99.99% to 99.999% or more. While the system 100 is described in connection with removing Ar from Xe gas, other gases may be processed by the system 100, and the system 100 is not limited herein.

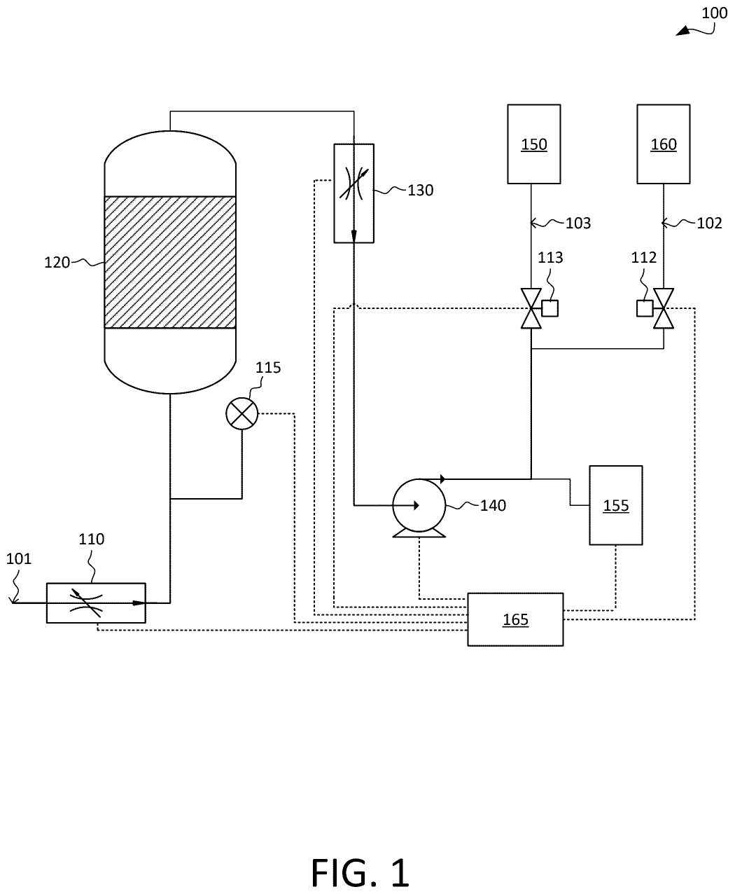

As shown in FIG. 1, the system 100 may comprise a gas column 120. The gas column 120 may contain an adsorbent. The adsorbent may be configured to preferentially adsorb Xe compared to Ar. The adsorbent may be a zeolite or activated carbon material. In an instance, the adsorbent may be Kostrolith NaMSXK, SorboNorit B3, or other adsorbent materials selected to preferentially adsorb certain gases compared to others (Xe, Ar, or others).

The system 100 may further comprise an input mass flow controller 110 and an output mass flow controller 130 connected to the input and output ends of the gas column 120, respectively. An input mass flow rate of the input mass flow controller 110 may be greater than an output mass flow rate of the output mass flow controller 130. For example, the input mass flow rate of the input mass flow controller 110 may be up to 3 slm. The input mass flow controller 110 may be configured to receive an input gas via an inlet port 101 of the system 100. The inlet port 101 may be connected to the upstream gas recycling system (e.g., the XRS) which provides the input gas.

The system 100 may further comprise an input pressure indicator 115 configured to measure the pressure in the gas column 120.

The system 100 may further comprise a pump 140. The pump 140 may be configured to produce a vacuum pressure to purge or extract gas from the gas column 120 to an outlet port 102 or an exhaust port 103 of the system 100. For example, an inlet of the pump 140 may be connected to the output mass flow controller 130, and an outlet of the pump 140 may be connected to the outlet port 102 and the exhaust port 103. The vacuum pressure may be less than 1bara (e.g., 0.0 to 0.02 bara). In some embodiments, the pump 140 may be a scroll pump or a different type of pump. The system 100 may further comprise an outlet valve 112 configured to control flow to the outlet port 102 and an exhaust valve 113 configured to control flow to the exhaust port 103. Accordingly, the pump 140 may be configured to extract gas from the gas column 120 to the outlet port 102 or the exhaust port 103 based on which of the outlet valve 112 or the exhaust valve 113 is open.

The outlet port 102 may be connected to at storage tank 160 configured to store gas. Alternatively, the outlet port 102 may be connected to a semiconductor inspection system to directly supply gas used in inspection processes.

The exhaust port 103 may be connected to a recirculation system 150. The recirculation system may be configured to direct the output gas from the gas column 120 back to the gas recycling system (e.g., XRS).

The system 100 may further comprise a residual gas analyzer (RGA) 155. The RGA 155 may be configured to receive a gas sample of the output gas from the gas column 120. For example, the RGA 155 may be connected to the outlet of the pump 140. The RGA 155 may be configured to measure one or more properties of the gas sample. For example, the RGA 155 may be configured to measure an Ar concentration, Xe concentration, or concentration of another gas present in the gas sample. The properties of the gas sample may be used to determine when the output gas from the gas column 120 is sufficiently purified to produce a purified gas.

The system 100 may further comprise a processor 165. The processor 165 may include a microprocessor, a microcontroller, or other devices. The processor 165 may be coupled to the components of the system 100 in any suitable manner (e.g., via one or more transmission media, which may include wired and/or wireless transmission media) such that the processor 165 can receive output. The processor 165 may be configured to perform a number of functions using the output. The processor 165 optionally may be in electronic communication with an inspection tool, a metrology tool, a repair tool, or a review tool (not illustrated) to receive additional information or send instructions. For example, the processor 165 may be in electronic communication with a gas recycling system (e.g., XRS).

The processor 165 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 165 may be disposed in or otherwise part of the system 100 or another device. In an example, the processor 165 may be part of a standalone control unit or in a centralized quality control unit. Multiple processors 165 may be used, defining multiple subsystems of the system 100.

The processor 165 may be implemented in practice by any combination of hardware, software, and firmware. Also, its functions as described herein may be performed by one unit, or divided up among different components, each of which may be implemented in turn by any combination of hardware, software and firmware. Program code or instructions for the processor 165 to implement various methods and functions may be stored in readable storage media, such as a memory.

If the system 100 includes more than one subsystem, then the different processors 165 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 165 may be configured to perform a number of functions using the output of the system 100 or other output. For instance, the processor 165 may be configured to send the output to an electronic data storage unit or another storage medium. The processor 165 may be further configured as described herein.

The processor 165 may be configured according to any of the embodiments described herein. The processor 165 also may be configured to perform other functions or additional steps using the output of the system 100 or using images or data from other sources.

The processor 165 may be communicatively coupled to any of the various components or sub-systems of system 100 in any manner known in the art. Moreover, the processor 165 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 165 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, or wireless transmission link. For instance, the various steps described throughout the present disclosure may be carried out by a single processor 165 (or computer subsystem) or, alternatively, multiple processors 165 (or multiple computer subsystems). Moreover, different sub-systems of the system 100 may include one or more computing or logic systems. Therefore, the above description should not be interpreted as a limitation on the present disclosure but merely an illustration.

The processor 165 may be in electronic communication with each valve of the system 100. For example, the processor 165 may be configured to send instructions to the outlet valve 112 to open and direct gas to the outlet port 102, and the processor 165 may be configured to send instructions to the exhaust valve 113 to open and direct gas to the exhaust port 103. The processor 165 may be similarly configured to send instructions to the outlet valve 112 and the exhaust valve to close to restrict gas flow from the outlet port 102 and the exhaust port 103, respectively.

The processor 165 may be in electronic communication with each pressure indicator of the system 100. For example, the processor 165 may be configured to receive pressure measurements from the input pressure indicator 115 to receive measurements of the pressure of the gas column 120.

The processor 165 may be in electronic communication with the input mass flow controller 110 and the output mass flow controller 130. For example, the processor 165 may be configured to send instructions to the input mass flow controller 110 and the output mass flow controller 130 to control the input and output of gas from the gas column 120.

The processor 165 may be in electronic communication with the pump 140. For example, the processor 165 may be configured to send instructions to the pump 140 to operate or stop operating. In some embodiments, the pump 140 may be operating throughout the process of purifying the gas through the system 100, or the pump 140 may be turned on and off by the processor 165 at various times during the process of purifying the gas through the system 100.

The processor 165 may be in electronic communication with the RGA 155. For example, the processor 165 may be configured to receive concentration measurements of the output gas from the RGA 155. The processor 165 may be configured to determine the purified gas as having an Ar concentration of less than 0.01%, which may produce purified gas comprising at least 99.99% Xe. In some embodiments, the purified gas may comprise at least 99.999% Xe (i.e., an Ar concentration of less than 0.001%).

In some embodiments, the processor 165 may be configured to determine that the purified gas comprises at least 99.99% Xe using a timer. For example, for a preset duration, the processor 165 may be configured to send instructions to the exhaust valve 113 to open to direct gas to the exhaust port 103 (with the outlet valve 112 being closed), and after the preset duration, the processor 165 may be configured to send instructions to the outlet valve 112 to open to direct gas to the outlet port 102 (with the exhaust valve 113 being closed).

The purified gas may be routed to the outlet port 102 by closing the exhaust valve 113, and opening the outlet valve 112.

The system 100 may include any additional pumps, valves, fittings, or other fluid devices to control the input of gas to the inlet port 101, exhaust of the output gas of the exhaust port 103, output of the purified gas to the outlet port 102, and movement of the gas through the gas column 120 and through the other elements of the system 100.

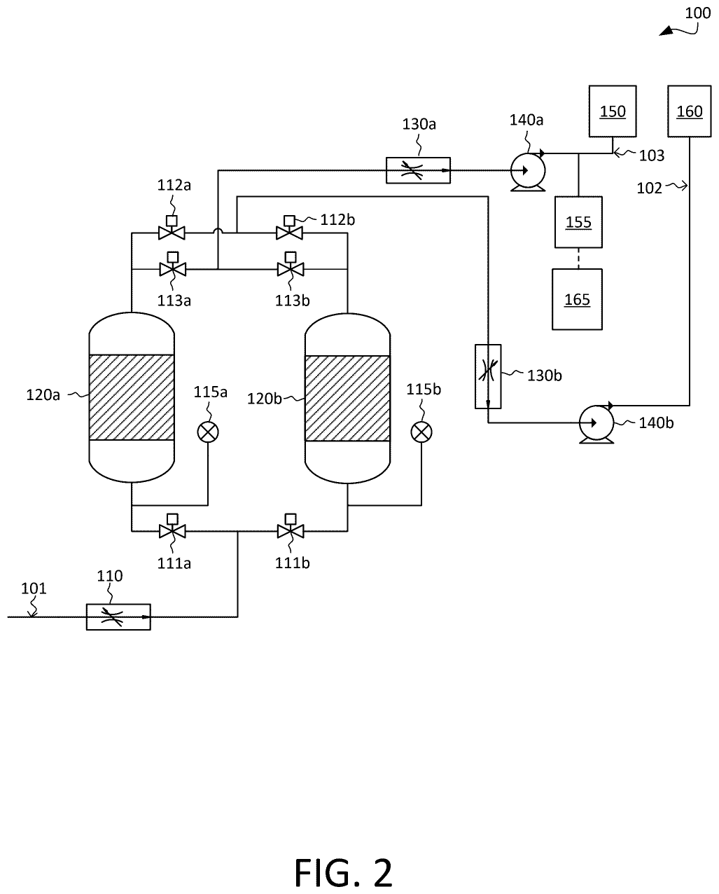

While the system 100 illustrated in FIG. 1 includes a single gas column 120, in some embodiments, the system 100 may comprise two or more gas columns 120 operating in parallel. For example, as shown in FIG. 2, the system 100 may comprise a first gas column 120a and a second gas column 120b.

The system 100 may further comprise a first inlet valve 111a configured to control input of gas from the input mass flow controller 110 to the first gas column 120a and a second inlet valve 111b configured to control input of gas from the input mass flow controller 110 to the second gas column 120b. The system 100 may further comprise a first outlet valve 112a configured to control output of gas from the first gas column 120a to the outlet port 102 and a second outlet valve 112b configured to control output of gas from the second gas column 120b to the outlet port 102. The system 100 may further comprise a first exhaust valve 113a configured to control output of gas from the first gas column 120a to the exhaust port 103 and a second exhaust valve 113b configured to control output of gas from the second gas column 120b to the exhaust port 103. The processor 165 may be in electronic communication with each the first inlet valve 111a, the second inlet valve 111b, the first outlet valve 112a, the second outlet valve 112b, the first exhaust valve 113a, and the second exhaust valve 113b to control each valve to open and close to control flow of gas through the first gas column 120a and the second gas column 120b to the outlet port 102 and the exhaust port 103.

The system 100 may further comprise a first pressure indicator 115a configured to measure the pressure in the first gas column 120a and a second pressure indicator 115b configured to measure the pressure in the second gas column 120b. The processor 165 may be in electronic communication with the first pressure indicator 115a and the second pressure indicator 115b to receive pressure measurements of the first gas column 120a and the second gas column 120b.

The system 100 may further comprise a first output mass flow controller 130a provided in the path of the output gas from the first gas column 120a and the second gas column 120b to the exhaust port 103, and a second output mass flow controller 130b provided in the path of the output gas from the first gas column 120a and the second gas column 120b to the outlet port 102. The processor 165 may be in electronic communication with the first output mass flow controller 130a and the second output mass flow controller 130b to control output of gas from the first gas column 120a and the second gas column 120b to the outlet port 102 and the exhaust port 103.

Optionally, the system 100 may further comprise a first pump 140a configured to extract gas from the first gas column 120a and the second gas column 120b to the exhaust port 103. The system 100 may further comprise a second pump 140b configured to extract gas from the first gas column 120a and the second gas column 120b to the output port 102. The processor 165 may be in electronic communication with the first pump 140a and the second pump 140b to control extraction of gas from the first gas column 120a and the second gas column 120b to the outlet port 102 and the exhaust port 103.

In some embodiments, the first gas column 120a and the second gas column 120b may operate out of phase, which can enable constant (or near constant) input of higher Ar content gas and output of purified Xe gas. For example, the processor 165 may be configured to control the valves of the system 100 such that one of the first gas column 120a and the second gas column 120b is outputting purified gas to the outlet port 102 or exhausting gas to the exhaust port 103, while the other of the first gas column 120a and the second gas column 120b is in the process of purifying gas.

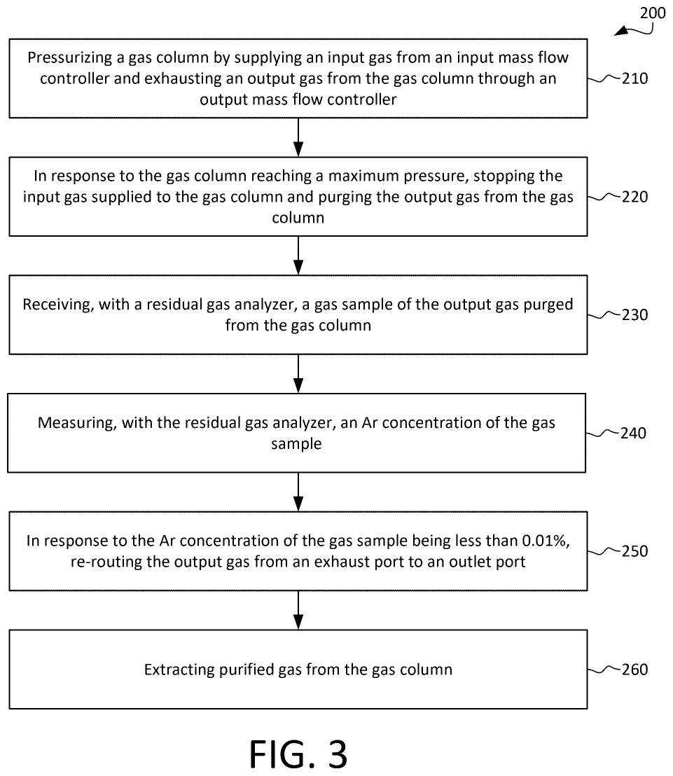

Another embodiment of the present disclosure provides a method 200. As shown in FIG. 3, the method 200 may comprise the following steps, which are described in conjunction with the exemplary components of the system 100 but are not limited herein.

At step 210, the gas column 120 is pressurized by supplying an input gas from the input mass flow controller 110 and exhausting an output gas from the gas column 120 through the output mass flow controller 130. The pump 140 may be configured to induce the flow of gas through the gas column 120. The input gas may comprise at least 99.9% Xe and 0.05% to 0.1% Ar. The input gas may be supplied to the gas column 120 with an inlet pressure of 3 to 6 bara. Due to the input mass flow rate of the input mass flow controller 110 being higher than the output mass flow rate of the output mass flow controller 130, the pressure in the gas column may gradually increase. As pressure increases, Xe may be preferentially adsorbed into the adsorbent contained in the gas column 120. Accordingly, the output gas exhausted from the gas column 120 has a higher Ar content compared to the input gas supplied to the gas column 120.

At step 220, in response to the gas column 120 reaching a maximum pressure, the input gas supplied to the gas column 120 is stopped, and the output gas is purged from the gas column 120. In some embodiments, the maximum pressure reached in the gas column may be up to 5 bara. When the maximum pressure in the gas column 120 is reached, the input gas flowing into the gas column 120 has a similar rate to the output gas flowing out of the gas column 120, and there may be little to no adsorption of Xe into the adsorbent. Accordingly, the input gas flow may drive out the output gas flow to purge out gas with high Ar content. The output gas may comprise less than 99.9% Xe and greater than 0.1% Ar. The input mass flow controller 110 may be controlled to stop the supply of input gas to the gas column 120. In some embodiments, the input gas may be cut-off upstream from the input mass flow controller 110. In some embodiments, the output gas may be purged using the input gas or purified gas from a previous cycle. The output gas may be purged to the exhaust port 103. In some embodiments, the exhaust port 103 may be connected to a recirculation system 150, which may direct the output gas back to a gas recycling system (e.g., XRS) to re-process the high Ar content output gas.

In some embodiments, steps 210 and 220 may be optimized such that the partial pressure of Ar in the outlet flow is low enough to prevent excessive Ar adsorption into the adsorbent while minimizing the amount of Xe being released to the exhaust port 103. It should be understood that the optimized flow rate may change throughout steps 210 and 220. The flow rates may also depend on the temperature and volume of the gas column 120.

At step 260, purified gas is extracted from the gas column 120. The purified gas may be extracted from the outlet port 102 into a storage tank 160, to an inspection tool, or to another tool or use, which may depend on the particular application.

In some embodiments, before step 260, the method 200 may further comprise steps 230 and 240.

At step 230, the RGA 155 receives a gas sample of the output gas purged from the gas column 120.

At step 240, the RGA 155 measures an Ar concentration of the gas sample. As the output gas is purged from the gas column 120, the pressure in the gas column 120 may drop, causing Xe to desorb from the adsorbent. Accordingly, the concentration of Xe in the output gas will increase and the concentration of Ar in the output gas will decrease in each successive gas sample measured by the RGA 155. The RGA 155 may transmit the measurements to the processor 165.

At step 250, in response to the Ar concentration of the gas sample being less than 0.01%, the output gas of the gas column 120 is re-routed from the exhaust port 103 to the outlet port 102. When the processor 165 determines that the Ar concentration of the gas sample is less than 0.01%, the output gas may be considered purified gas, having an Xe concentration of 99.99% or greater. Under control of the processor 165, the outlet valve 112 may be opened, and the exhaust valve 113 may be closed to direct the output gas to the outlet port 102 rather than the exhaust port 103.

In some embodiments, the verification process of steps 230-250 may be performed downstream, and the RGA 155 may be external from the other elements of the system 100. In either case (i.e., with the RGA 155 integral with the system 100 or as an external element), the RGA 155 may be used to control process advancement of the method 200 or the RGA 155 may be used as a verification process before or after the steps of the method 200.

In some embodiments, the method 200 may proceed from step 220 to step 260 after a preset duration, without the verification process of steps 230-250 (e.g., without RGA 155). For example, after purging the output gas from the gas column 120 in step 220 for a preset duration, the purified gas can be extracted from the gas column 120 in step 260. For example, after the preset duration, the processor 165 may be configured to send instructions to the outlet valve 112 to open to direct gas to the outlet port 102 (with the exhaust valve 113 being closed).

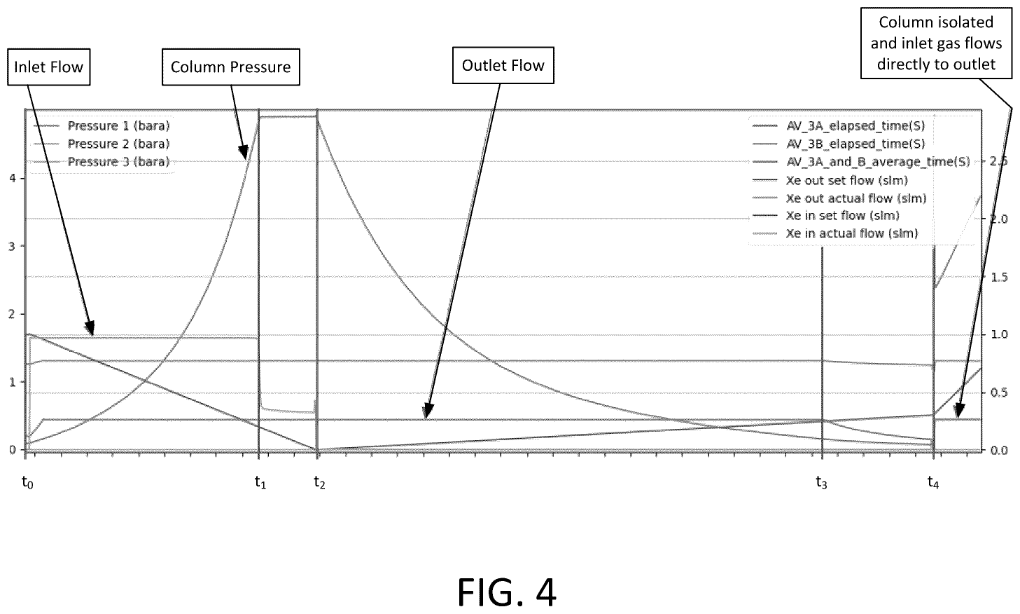

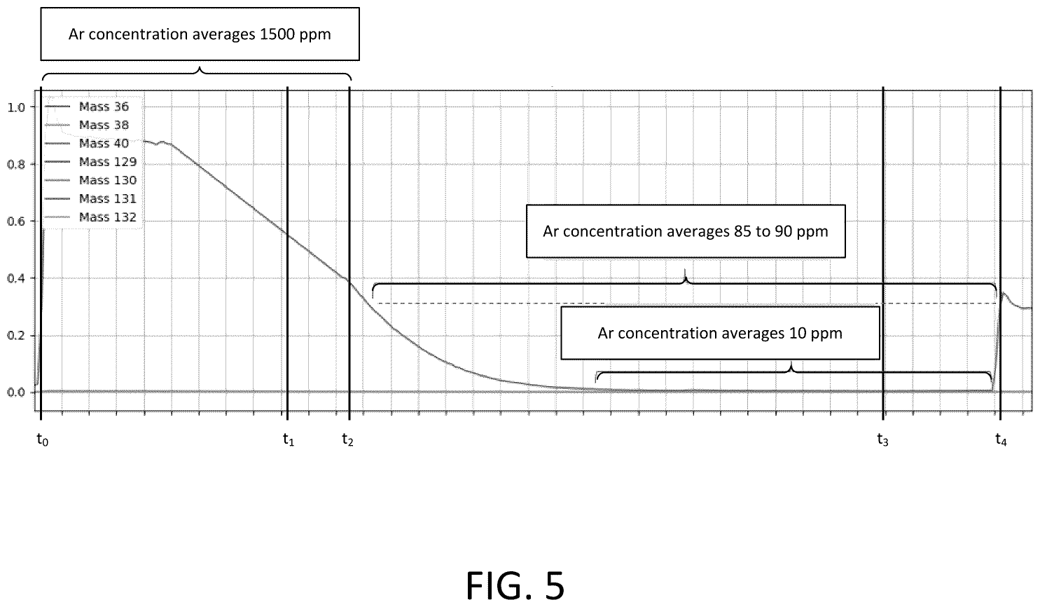

FIG. 4 and FIG. 5 illustrate example test data of purification of Xe gas using the system 100 and method 200 described above. In particular, FIG. 4 illustrates gas flow and pressure measurements of the gas column 120, and FIG. 5 illustrates Ar concentration measurements of the RGA 155. The test utilized an input gas of Xe having an Ar concentration of 640 ppm (i.e., about 99.936% Xe) and about 1 L of 1.2 mm to 2 mm (about 700 g) of Kostrolith NaMSXK adsorbent in the gas column 120.

At an initial condition t₀, the pressure in the gas column 120 is 0.1 bara, the input mass flow rate of the input mass flow controller 110 is 1 slm, and the output mass flow rate of the output mass flow controller 130 is 0.25 slm. After 53 mins at t₁, the pressure in the gas column 120 is 4.9 bara, the input mass flow rate is 0.35 slm, and the output mass flow rate is 0.25 slm. The time between t₀ and t₁ may correspond to the pressurization of step 210. As shown in FIG. 4, the pressure in the gas column 120 gradually increases until reaching a maximum pressure. During this time, Xe is adsorbed into the adsorbent, such that the Ar concentration of the output gas averages 1500 ppm.

After 1:06 hours at t₂, the pressure in the gas column 120 is 4.9 bara, the input mass flow rate is 0.0 slm, and the output mass flow rate is 0.25 slm. At this time, an estimated amount of 41 L of Xe was adsorbed into the adsorbent, and the input gas flow is stopped in correspondence with the stopping portion of step 220.

After 2:56 hours at t₃, the pressure in the gas column 120 is 0.16 bara, the input mass flow rate is 0.0 slm, and the output mass flow rate is decreasing to 0.0 slm. After 3:20 hours at t₄, the pressure in the gas column 120 is 0.1 bara, and the test is stopped. The time between t₂ and t₄ may correspond to the purging portion of step 220. During this time, the Ar concentration of the output gas reduces to an average of 85 ppm with 65% throughput and to an average of 10 ppm with 40% throughput to produce purified Xe gas (i.e., about 99.9915% Xe to about 99.999% Xe).

The results of the experiment above indicate that the method 200 may be configured to produce a purified gas comprising at least 99.99% Xe (including 99.999% Xe or more), without mixing with new clean purified Xe gas. In addition, the high Ar content gas exhausted with the method 200 may be recirculated through the XRS, such that loss of Xe gas is minimized. Thus, the system 100 and method 200 may provide an improved gas purification process with low cost and complexity, which may be applicable to low-volume and high-volume applications.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A method comprising:
pressurizing a gas column by supplying an input gas from an input mass flow controller and exhausting an output gas from the gas column through an output mass flow controller, wherein the input gas comprises at least 99.9% Xe and 0.05% to 0.1% Ar, the gas column contains an adsorbent, and an input mass flow rate of the input mass flow controller is greater than an output mass flow rate mass flow rate of the output mass flow controller to adsorb Xe into the adsorbent;
in response to the gas column reaching a maximum pressure, stopping the input gas supplied to the gas column and purging the output gas from the gas column, wherein the output gas comprises less than 99.9% Xe and greater than 0.1% Ar; and
extracting purified gas from the gas column to desorb the Xe from the adsorbent, wherein the purified gas comprises at least 99.99% Xe.

2. The method of claim 1, wherein before extracting the purified gas from the gas column, the method further comprises:
receiving, with a residual gas analyzer, a gas sample of the output gas purged from the gas column;
measuring, with the residual gas analyzer, an Ar concentration of the gas sample; and
in response to the Ar concentration of the gas sample being less than 0.01%, re-routing the output gas from an exhaust port to an outlet port.

3. The method of claim 2, wherein the exhaust port is connected to a gas recycling system configured to increase an Xe concentration of the output gas to up to 99.9% Xe.

4. The method of claim 2, wherein the outlet port is connected to a storage tank configured to store the purified gas.

5. The method of claim 2, wherein the outlet port is connected to a semiconductor inspection system configured to supply the purified gas.

6. The method of claim 1, wherein the input gas supplied to the gas column through the input mass flow controller is connected to a gas recycling system configured reduce an Ar concentration of the input gas to 0.05% to 0.1% Ar.

7. The method of claim 1, wherein the output gas is purged from the gas column by vacuum pressure from a vacuum pump.

8. The method of claim 1, wherein the purified gas comprises at least 99.999% Xe.

9. The method of claim 1, wherein the adsorbent is configured to preferentially adsorb Xe compared to Ar.

10. The method of claim 1, wherein the step of extracting the purified gas from the gas column is performed after a preset duration of purging the output gas from the gas column.
